(19) United States
(12) Patent Application Publication
(10) Pub. No.: US 2026/0132754 A1
(43) Pub. Date: May 14, 2026

(54) SYSTEMS AND METHODS OF ENGINE BRAKING USING HIGH PRESSURE FUEL PUMP

(71) Applicant: Ronny Alexander Mathew, Pune (IN)

(72) Inventor: Ronny Alexander Mathew, Pune (IN)

(21) Appl. No.: 19/372,841

(22) Filed: Oct. 29, 2025

(30) Foreign Application Priority Data
Nov. 8, 2024 (IN) 202441086014

(51) Int. Cl. F02D 41/12; F02D 13/04; F02M 37/00; F02M 37/06

(52) U.S. Cl. CPC F02D 41/12; F02D 13/04; F02M 37/0029; F02M 37/06; F02D 2200/0602; F02D 2200/60

(57) ABSTRACT

Systems and methods are disclosed for braking of a vehicle in response to a deceleration request. A fuel pump operates to pressurize the fuel system in response to the deceleration request to apply additional torque to the powertrain to brake the vehicle. The fuel pump can be operated as a primary means of braking the vehicle, or to supplement one or more other means of braking the vehicle, such as service brakes, engine brakes, exhaust brakes, regenerative braking, resistive braking, and/or aerodynamic braking.

### CROSS-REFERENCE TO RELATED APPLICATION

The present application claims priority to Indian Patent Application No. 202441086014 filed Nov. 8, 2024, which is incorporated herein by reference.

### BACKGROUND

Vehicles may include service (friction) brakes and one or more various supplemental powertrain braking options, including engine braking such as compression release braking, exhaust braking, regenerative braking, resistive braking such as hydrodynamic and electromagnetic retarders, and aerodynamic braking. These various braking systems can be implemented in order to supplement service braking to reduce wear of friction braking components, decrease maintenance and vehicle down time, provide the desired operational outcomes, provide additional braking power when needed, and improve safety during vehicle operation. However, there remains a need for additional improvement in this area.

### SUMMARY

The present application discloses systems and methods for vehicle braking in response to a deceleration request for a vehicle that includes utilizing a fuel pump to cause braking. The fuel pump pressurizes the fuel system in response to the deceleration request to add torque to the powertrain and facilitate vehicle braking. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example vehicle including a powertrain and a braking system.

FIG. 2 is a schematic view of an embodiment of a fuel system of the vehicle of FIG. 1.

FIG. 3 is a schematic flow diagram of one embodiment of a procedure for braking the vehicle of FIG. 1 with the fuel system of FIG. 2.

FIG. 4 is a schematic flow diagram of one embodiment of a procedure for managing braking of the vehicle of FIG. 1 with the fuel system of FIG. 2.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

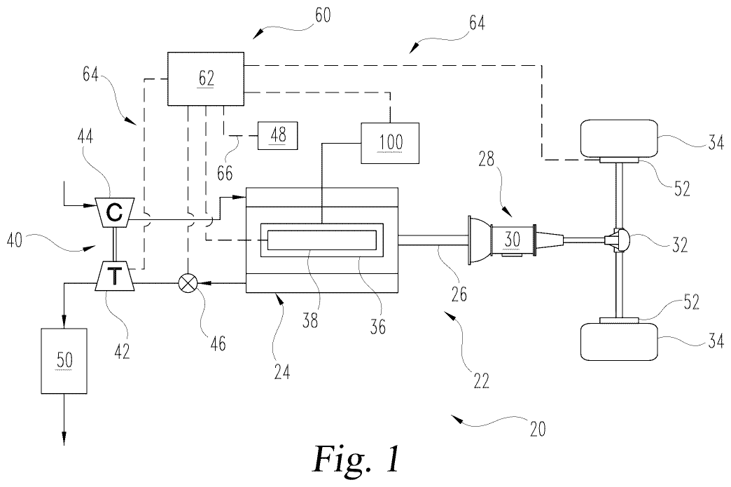

With reference to FIG. 1, there is illustrated an example vehicle 20. In the illustrated embodiment, vehicle 20 includes a powertrain 22 and a fuel system 100 operably connected to powertrain 22. Powertrain 22 may be any suitable powertrain for a vehicle 20 that is operable to propel vehicle 20. Powertrain 22 may include any suitable prime mover or prime mover combinations, including an internal combustion engine used alone or in combination with one or more of an electric motor, a fuel cell, and/or an energy storage device.

In the illustrated embodiment, powertrain 22 is shown with an internal combustion engine 24 operatively coupled to and configured to provide torque to an output such as drive shaft 26. Drive shaft 26 is coupled to a driveline 28. Driveline 28 may include a transmission 30, a differential 32, and ground engaging wheels 34. Other embodiments contemplate tracks or other types of ground engaging structures instead of wheels.

In the illustrated embodiment, vehicle 20 is propelled along a road or route by wheels 34, which are configured and provided as rear wheels. Wheels 34 include service brakes 52 coupled thereto to provide friction braking of vehicle 20. In other embodiments, front-wheel drive, four-wheel drive, and all-wheel drive approaches are contemplated with associated service brakes. In various embodiments, vehicle 20 may be configured and provided as an on-road bus, delivery truck, a service truck, passenger truck, passenger car, or the like. In other aspects, vehicle 20 may be configured and provided as a different type of vehicle, including other types of on-road or off-road vehicles.

Transmission 30 may be configured and provided in a number of forms. In some forms, transmission 30 may be configured and provided as a manual transmission including a gearbox and an operator-actuated internal clutch. In some forms, transmission 30 may be configured and provided as an automated manual transmission including a gearbox and an internal clutch that may be automatically actuated or actuated in response to operator input. In some forms, transmission 30 may be configured and provided as an automatic transmission including a planetary gear set. In some forms, transmission 30 may be configured and provided as continuously variable transmission.

In the illustrated embodiment, engine 24 is configured as a turbocharged engine including one or more cylinders 36 for combustion of an air-fuel mixture and an engine braking system 38 associated with cylinders 36. Engine braking system 38 may be provided in any suitable form that is are configured and operable to reduce cylinder pressure during a compression stroke of engine 24 relative to the cylinder pressure that would otherwise result from the compression stroke. In some forms, engine braking system 38 may be configured and provided to include cylinder deactivation (CDA) operation during which the intake valves and/or exhaust valves of one or more of the engine cylinders remains closed.

In some forms, engine braking system 38 may be configured and provided as a compression release braking system. In some such forms, a hydraulic or electric actuator may be provided in a valve train between a valve of engine 24 and a valve cam of engine 24 and may be electronically controlled to vary the response of the valve to the valve cam. For example, such an actuator may be provided to selectably maintain an exhaust valve and/or intake valve open and/or closed during at least a part of the piston stroke of the engine 24. In certain embodiments, the engine braking system 38 includes a braking disable switch (not shown). The braking disable switch can be manually controlled by the operator, and/or automatically controlled by the electronic control system based on vehicle location data. The braking disable switch indicates that engine braking is not to be utilized, such in cities or other areas where compression braking is not allowed by regulation.

Powertrain 22 may be provided with a turbocharger 40 including a turbine 42 and a compressor 44. Turbine 42 extracts energy from the exhaust gas from engine 24 to drive compressor 44 to compress charge air flow to engine 24. Turbine 42 can include a controllable inlet or wastegate that can be controlled as a mechanical braking device to decelerate vehicle 20. For example, turbine 42 may include a variable geometry turbocharger (VGT). Certain VGT devices can be adjusted to produce back pressure on the engine 24 and provide an exhaust brake effect that, in moving toward a closed position, partially blocks an exhaust stream and applies back pressure on the engine resulting in a negative crankshaft torque amount. Still other exemplary exhaust braking systems include an exhaust throttle 46 or wastegate to provide an exhaust brake.

The vehicle 20 further includes a deceleration request device 48 that provides a deceleration or braking request. An exemplary deceleration request device 48 includes a brake pedal and brake pedal position sensor that receives an input from the brake pedal when actuated by the operator. Other deceleration request devices 48 include, for example, an adaptive cruise control system, a predictive cruise control system, an automated driving system, an advanced driver assistance system, a dynamic powertrain controller that automatically control powertrain output in response to look ahead data and target vehicle speeds along a route, an autonomous vehicle controller, an anti-lock braking (ABS) system, a power take-off (PTO) device, an electronic vehicle stability control system, a radar or LiDAR based automated braking system, and/or a network or datalink parameter communicating a deceleration request. Any deceleration request device 48 operable to provide a deceleration or brake request, or a value that can be correlated to a present deceleration or brake request, is contemplated herein.

In the illustrated embodiment, vehicle 20 includes an exhaust aftertreatment system 50 provided downstream of engine 24 that receives the exhaust flow and treats constituents in the exhaust flow for emissions reduction purposes. The exhaust aftertreatment system 50 may include one or more aftertreatment devices, such as a selective catalyst reduction (SCR) catalyst, three-way catalyst, oxidation catalyst, particular filter, and any suitable device or devices for exhaust aftertreatment.

The vehicle 20 includes an electronic control system (ECS) 60 that includes a plurality of control components and structures. ECS 60 may include one or more programmable microprocessors or microcontrollers of a solid-state, integrated circuit type that are provided in one or more constituent control units of ECS 60. It is also contemplated that ECS 60 may include other types of integrated circuits and/or discrete circuit control units. ECS 60 may include one or more electronic control units (ECU), such as an engine control unit, a transmission control unit, a fuel control unit, and a braking management control unit. ECS 60 may include one or more ECUs that can be separate controllers or integrated fully or in part in one or more other control units.

As discussed further below, ECS 60 can be configured to include a braking management or control system that provides control of fuel system 100 along with one or more of service brakes 52, engine brake 38, turbine 42, and/or exhaust brake 46 to provide braking of vehicle 20. The ECS 60 can include, for example, an electronic control unit 62 for braking control that is operatively coupled with and configured for communication over a network 64. Network 64 may be configured as a controller area network (CAN) or another type of network providing communication capabilities. ECS 60 and/or control unit 62 is also operatively coupled with various components and systems of the vehicle 20 via network 64 or one or more additional or alternative networks.

ECS 60 can be implemented in a number of configurations that combine or distribute control components, functions, or processes across one or more control units in various manners. ECS 60 executes operating logic, such as brake management logic 100 that defines various control, management, and/or regulation functions. This operating logic may be in the form of dedicated hardware, such as a hardwired state machine, analog calculating machine, programming instructions, and/or a different form as would occur to those skilled in the art. ECS 60 may be provided as a single component or a collection of operatively coupled components; and may be comprised of digital circuitry, analog circuitry, or a hybrid combination of both of these types. When of a multi-component form, ECS 60 may have one or more components remotely located relative to the others in a distributed arrangement. ECS 60 can include multiple processing units arranged to operate independently, in a pipeline processing arrangement, in a parallel processing arrangement, or the like. It shall be further appreciated that ECS 60 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

Certain operations described herein include determining one or more parameters. Determining, as utilized herein, includes calculating values and/or receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art, and/or by receiving a value by which the determined parameter can be calculated, and/or by referencing a default value that is determined to be the parameter value.

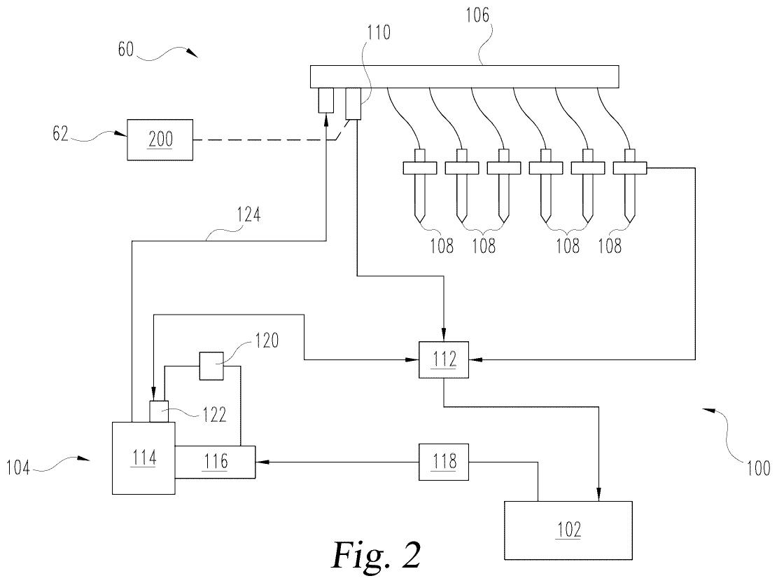

In certain embodiments, the ECS 60 includes one or more electronic control units 62 structured to functionally execute one or more operations to control braking/deceleration of vehicle 20. Referring further to FIG. 2, electronic control unit 62 includes brake management logic 200 that resides on a memory thereof that is executable by a processor of electronic control unit to receive a deceleration request 66 from deceleration request device 48, determine a braking capability of at least fuel system 100, and allocate at least a portion of the deceleration request 66 to fuel system 100 to satisfy the deceleration request 66 by using a fuel pump of fuel system 100 to increase the torque on powertrain 22.

Vehicle 20 includes fuel system 100, an example of which is shown further in FIG. 2, for providing fuel to powertrain 22 during operation of vehicle 20. In the illustrated embodiment, fuel system 100 includes a fuel tank 102 for storing fuel and a pump assembly 104 for receiving fuel from fuel tank 102. Fuel from fuel tank 102 can be filtered through a primary filter 118 between fuel tank 102 and pump assembly 104. Fuel system 100 also includes a high pressure common rail 106 that receives pressurized fuel from pump assembly 104 and a plurality of fuel injectors 108 connected to common rail 106. Fuel injectors 108 can be controlled to be ON to inject fuel into cylinders 36 of engine 24 and to be OFF when fuel is not to be injected into cylinders 36, such as during deceleration request 66.

Fuel system 100 also includes a control valve 110 at common rail 106 that is connected to a fuel return manifold 112. Fuel from common rail 106 is returned to fuel tank 102 through control valve 110 when control valve 110 is open via fuel return manifold 112. Fuel injectors 108 are also connected to fuel return manifold 112 to return un-injected fuel from fuel injectors 108 to fuel tank 102 via fuel return manifold 112.

Control valve 110 is operable to open electronically via one or more commands from electronic control unit 62 and/or mechanically in response to the fuel pressure in common rail 106 exceeding a valve opening threshold that causes control valve 110 to open. As discussed further below, in an embodiment, control valve 110 is a pressure relief valve that is controlled by electronic control unit 62 to be fully opened while injectors 108 are OFF or providing insubstantial fueling (e.g. pilot injections) to provide maximum fuel flow for pressurizing common rail 106 to a maximum pressure. The pressure relief valve type of control valve 110 may also be opened intermediately to produce intermediate pressures at common rail 106 in response to a deceleration request while injectors 108 are OFF or providing insubstantial fueling. The intermediate pressures are less than the maximum pressure threshold. In another embodiment, control valve 110 is a mechanical dump valve that opens automatically without a control command when the fuel pressure in common rail 106 is increased to a maximum pressure threshold by operation of fuel pump assembly 104 while injectors 108 are OFF or providing insubstantial fueling.

Pump assembly 104 of fuel system 100 may include a high pressure fuel pump 114 and pump gears 116 that are driven by or linked to drive shaft 26 of engine 24 to pressurize the fuel from fuel tank 102. Fuel pump 114 is connected to common rail 106 with high pressure fuel line 124. Pump assembly 104 may also include a secondary filter 120 that filters the pressurized fuel provided to an inlet metering valve 122 upstream of fuel pump 114. Inlet metering valve 122 is operable to meter the flow of high pressure fuel into fuel pump 114 for fuel pump 114 to pressurize the fuel to common rail 106 and maintain a minimum or target pressure at common rail 106. Inlet metering valve 122 is also connected to fuel return manifold 112 to shunt fuel that is not inlet by metering valve 122 into fuel pump 114 back to fuel tank 102.

In response to a deceleration or brake request 66, electronic controller 62 includes brake management logic 200 that receives one or more inputs associated with the braking capability of fuel system 100 and allocates all or at least a portion of the deceleration request to fuel system 100. If one or more of engine braking system 38, the exhaust braking system, and/or any other one or more braking systems of vehicle 20 is provided, at least a portion of the deceleration request may be allocated thereto. The fuel system 100 is controlled by electronic control unit 62 to open control valve 110 or to override a nominal operating pressure in common rail 106 to create a demand for pressurized fuel at common rail 106. The open control valve 110 and/or increased pressure demand at common rail 106 causes inlet metering valve 122 to open to provide fuel for pumping by fuel pump 114 during the deceleration request, which increases the load or frictional torque on powertrain 22 and decelerates vehicle 20.

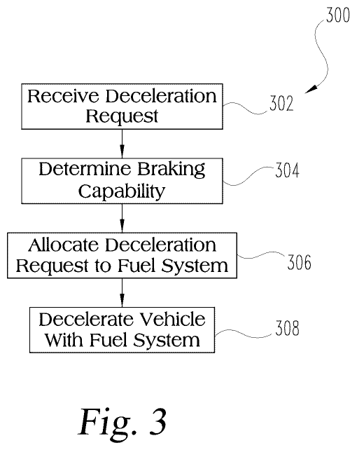

Referring to FIG. 3, an embodiment of a method 300 for executing brake management logic 200 is illustrated. Method 300 includes an operation 302 for receiving a deceleration request 66 for decelerating the vehicle 20. Deceleration request 66 can be produced, for example, by deceleration request device 48 and received at electronic control unit 62 during operation of vehicle 20.

Method 300 includes an operation 304 for determining a braking capability of fuel system 100 upon receiving deceleration request 66. The braking capability of fuel system 100 may be based on, for example, the type of control valve 110, the position of a brake selector switch enabling or disabling one or more other braking systems, and pressure conditions/capabilities of the fuel system 100, such the fuel pressure in common rail 106 to be created by fuel supplied by fuel pump 114 to common rail 106. The condition/capability of fuel system 100 to receive fuel to pressurize common rail 106 determines the amount of frictional torque fuel pump 114 will apply to powertrain 22 to decelerate driveline 28 while the deceleration request 66 is active.

Method 300 continues at operation 306 to allocate at least part of the deceleration request 66 to fuel system 100 based on the braking capability of fuel system 100 and/or other braking systems of vehicle 20. In an embodiment, fuel system 100 provides all the deceleration for vehicle 20 during a particular deceleration request 66. In other embodiment, the deceleration request 66 is allocated between fuel system 100 and one or more other braking systems, such as engine braking, exhaust braking, service braking, or other braking system. Method 300 continues at operation 308 to decelerate vehicle 20 using fuel pump 114 of fuel system 100 to pressurize common rail 106 of fuel system 100 to add friction torque to powertrain 22 and decelerate driveline 28 during the deceleration request 66.

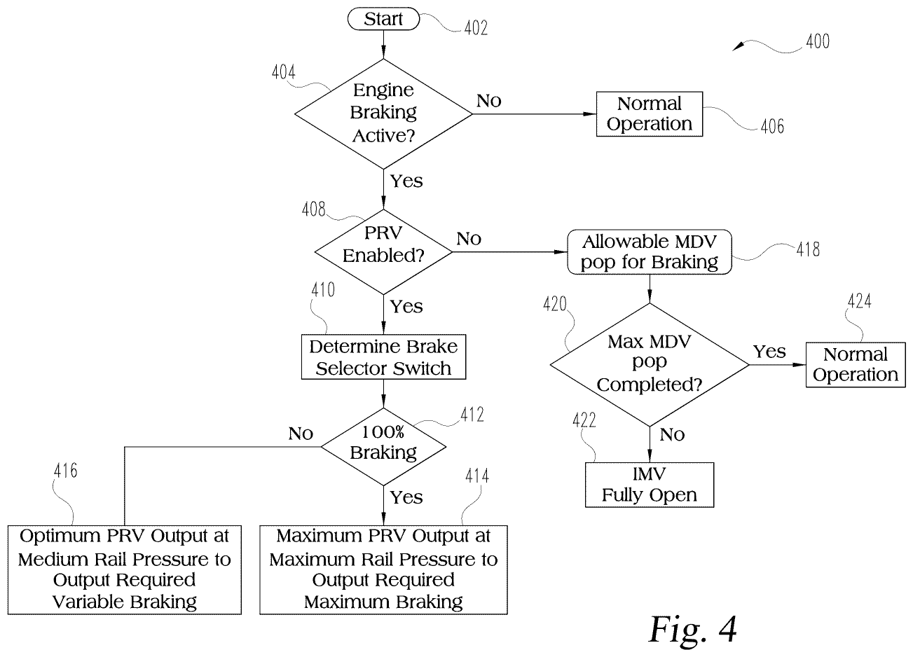

Referring to FIG. 4, another embodiment method 400 is shown for braking vehicle 20 with fuel system 100. Method 400 starts at 402 and continues at conditional 404 to determine if braking for powertrain 22 is active. For example, braking can be considered active if a deceleration request 66 is present or received by electronic control unit 62. If conditional 404 is NO, method 400 continues at operation 406 to operate powertrain 22 normally without providing braking from fuel pump 114 of fuel system 100.

If conditional 404 is YES, method 400 continues at conditional 408 to determine if the control valve 110 is a pressure relief type of control valve (PRV). The PRV type of control valve 110 can be actively electronically controlled to open with fuel system 100 to provide braking of powertrain 22 by creating a demand for fuel at common rail 106 while providing little or no fuel to cylinders 36.

If conditional 408 is YES, method 400 continues at operation 410. In an embodiment, operation 401 determines a brake selector switch position. The brake selector switch position can provide an indication of an amounting of braking to be provided by opening of the PRV type of control valve 110 during the deceleration request. At conditional 412, it is determined whether the brake selector switch is positioned for 100% braking from fuel system 100 using the PRV type of control valve 110.

If conditional 412 is YES, fuel system 100 can provide 100% of its braking capability. Method 400 then continues at operation 414 to allow electronic control unit 62 to provide maximum output of fuel from the PRV type of control valve 110, allowing maximum fuel flow to from control valve 110 to fuel return manifold 112. The fully open PRV type of control valve 110 prevents the fuel pressure in common rail from increasing to its maximum allowable pressure. This causes inlet metering valve 122 to open and be maintained in the open position during the deceleration request 66 to provide fuel to fuel pump 114 so that fuel pump 114 operates continually to try and increase fuel pressure. Since fuel pump 114 is driven by a connection with drive shaft 126, frictional torque is added to powertrain 22 and driveline 28 is decelerated.

If conditional 412 is NO, method 400 continues at operation 416 in which electronic control unit 62 provides variable braking using fuel system 100. Operation 416 includes opening control valve 110 to an intermediate position less than 100% open to provide a fuel flow output from the PRV type of control valve 110 to fuel return manifold 112 that is less than its maximum output. Fuel pump 114 thus is able to provide variable braking of powertrain 22 by modulating the flow of fuel through the PRV type of control valve 110 in response to and during the deceleration request 66.

If conditional 408 is NO and the control valve 110 is not indicated to be a PRV type of control valve, then control valve 110 is determined to be a mechanical dump type of control valve 110. The mechanical dump type of control valve 110 is not electronically controlled to open and close, but rather opens automatically when the pressure in common rail 106 exceeds a threshold pressure.

Method 400 continues at operation 418 to determine the allowable mechanical dump valve pop, or pressure threshold, that causes opening of the mechanical dump type of control valve 110 for braking powertrain 22. Method 400 continues at conditional 420 to determine if the maximum allowable pressure for opening the mechanical dump type of control valve 110 has been reached. If conditional 420 is NO, the inlet metering valve 122 remains fully open to allow fuel pump 114 to increase the rail pressure at common rail 106 during the deceleration request 66. If conditional 420 is YES, the maximum pressure of common rail 106 has been obtained, and method 400 continues at operation 424 where normal operation of powertrain 22 is conducted without braking provided by fuel pump 114.

As is evident from the figures and text presented above, and claims that follow, a variety of aspects and embodiments according to the present application are contemplated. According to one aspect, a method for braking a vehicle that includes a powertrain and a fuel system includes receiving a deceleration request for decelerating the vehicle; allocating at least part of the deceleration request to the fuel system based on a braking capability of the fuel system; and decelerating the vehicle using a fuel pump of the fuel system to pressurize the fuel system to add torque to the powertrain during the deceleration request.

In an embodiment, the method includes determining a braking capability of the fuel system based on a pressure of the fuel system and determining a braking capability of an engine braking system of the vehicle. The method also includes allocating at least part of the deceleration request to the engine braking system in addition to allocating at least part of the deceleration request to the fuel system and decelerating the vehicle using the fuel pump and the engine braking system.

In an embodiment, the method includes determining a braking capability of the fuel system based on a pressure of the fuel system and determining a braking capability of an exhaust braking system of the vehicle. The method also includes allocating at least part of the deceleration request to the exhaust braking system in addition to allocating at least part of the deceleration request to the fuel system and decelerating the vehicle using the fuel pump and the exhaust braking system.

In an embodiment, decelerating the vehicle includes opening a pressure relief valve in the fuel system downstream of the fuel pump in response to the deceleration request to create a demand for increased fuel pressure in the fuel system without providing fuel to the powertrain.

In an embodiment, opening the pressure relief valve causes an inlet metering valve to open upstream of the fuel pump to provide fuel to the fuel pump during the deceleration request.

In an embodiment, opening the pressure relief valve includes modulating the opening of the pressure relief valve based on the determined braking capability of the fuel system.

In an embodiment, determining the braking capability of the fuel system includes determining a position of a brake selector switch of the vehicle.

In an embodiment, determining the brake selector switch is in a first position indicates pressurizing the fuel system to a maximum target pressure in response to the deceleration request for maximum braking capability of the fuel system. Determining the brake selector switch is in a second position indicates pressurizing the fuel system is increased to an intermediate target pressure in response to the deceleration request for variable braking capability of the fuel system.

In an embodiment, decelerating the vehicle includes increasing the pressure in the fuel system downstream of the fuel pump in response to the deceleration request and opening a mechanical dump valve in the fuel system in response to increasing the pressure of the fuel system.

In an embodiment, the method includes fully opening an inlet metering valve in response to the mechanical dump valve opening to provide fuel to the fuel pump.

According to another aspect of the disclosure, a vehicle is disclosed that includes a powertrain coupled to a drive shaft, one or more grounding engaging wheels that are driven by the drive shaft, and a fuel system including a fuel pump coupled to the powertrain. The fuel pump is configured to pressurize fuel in the fuel system to fuel the powertrain. The vehicle also includes a deceleration request device configured to provide a deceleration request to decelerate the vehicle and at least one controller configured to receive the deceleration request and output one or more braking commands to the fuel system. The one or more braking commands from the controller decelerate the vehicle by increasing the pressure of the fuel system with the fuel pump to add torque to the powertrain to decelerate the vehicle.

In an embodiment, the fuel system includes a pressure relief valve downstream of the fuel pump, and the one or more braking commands opens the pressure relief valve in response to the deceleration request.

In an embodiment, the fuel system includes an inlet metering valve upstream of the fuel pump that opens in response to the pressure relief valve opening to provide fuel to the fuel pump during deceleration without fueling the powertrain.

In an embodiment, the fuel system includes a common rail connected to a plurality of fuel injectors, and the pressure relief valve is to connected to the common rail upstream of the plurality of fuel injectors.

In an embodiment, the pressure relief valve is connected to a fuel tank of the fuel system so that fuel from the fuel pump flows through the pressure relief valve to the fuel tank during deceleration of the vehicle.

In an embodiment, the controller is configured to modulate an opening of the pressure relief valve from a fully open position that maximizes a braking capability of the fuel pump to an intermediate position in which the braking capability of the fuel pump is less than its maximum.

In an embodiment, the fuel system includes a mechanical dump valve downstream of the fuel pump. The one or more braking commands increases a pressure of the fuel system to open the mechanical dump valve in response to the deceleration request.

In an embodiment, the powertrain includes an internal combustion engine capable of rotating the drive shaft and the deceleration request device comprises a brake pedal.

In an embodiment, the vehicle includes a service braking system and at least one of an exhaust braking system and an engine braking system.

In an embodiment, the at least one controller is configured to output one or more braking commands to the at least one of the exhaust braking system and the engine braking system to decelerate the vehicle in addition to using the fuel pump to decelerate the vehicle.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method for braking a vehicle that includes a powertrain and a fuel system, the method comprising:
receiving a deceleration request for decelerating the vehicle;
allocating at least part of the deceleration request to the fuel system based on a braking capability of the fuel system; and
decelerating the vehicle using a fuel pump of the fuel system to pressurize the fuel system to add torque to the powertrain during the deceleration request.

2. The method according to claim 1, further comprising:
determining a braking capability of the fuel system based on a pressure of the fuel system and determining a braking capability of an engine braking system of the vehicle;
allocating at least part of the deceleration request to the engine braking system in addition to allocating at least part of the deceleration request to the fuel system; and
decelerating the vehicle using the fuel pump and the engine braking system.

3. The method according to claim 1, comprising:
determining a braking capability of the fuel system based on a pressure of the fuel system and determining a braking capability of an exhaust braking system of the vehicle;
allocating at least part of the deceleration request to the exhaust braking system in addition to allocating at least part of the deceleration request to the fuel system; and
decelerating the vehicle using the fuel pump and the exhaust braking system.

4. The method according to claim 1, wherein decelerating the vehicle includes opening a pressure relief valve in the fuel system downstream of the fuel pump in response to the deceleration request to create a demand for increased fuel pressure in the fuel system without providing fuel to the powertrain.

5. The method according to claim 4, wherein opening the pressure relief valve causes an inlet metering valve to open upstream of the fuel pump to provide fuel to the fuel pump during the deceleration request.

6. The method according to claim 5, wherein opening the pressure relief valve includes modulating the opening of the pressure relief valve based on the determined braking capability of the fuel system.

7. The method according to claim 1, wherein determining the braking capability of the fuel system includes determining a position of a brake selector switch of the vehicle.

8. The method according to claim 7, wherein:
determining the brake selector switch is in a first position indicates pressurizing the fuel system to a maximum target pressure in response to the deceleration request for maximum braking capability of the fuel system; and
determining the brake selector switch is in a second position indicates pressurizing the fuel system is increased to an intermediate target pressure in response to the deceleration request for variable braking capability of the fuel system.

9. The method according to claim 1, wherein decelerating the vehicle includes increasing the pressure in the fuel system downstream of the fuel pump in response to the deceleration request and opening a mechanical dump valve in the fuel system in response to increasing the pressure of the fuel system.

10. The method according to claim 9, comprising fully opening an inlet metering valve in response to the mechanical dump valve opening to provide fuel to the fuel pump.

11. A vehicle, comprising:
a powertrain coupled to a drive shaft;
one or more grounding engaging wheels that are driven by the drive shaft;
a fuel system including a fuel pump coupled to the powertrain, the fuel pump configured to pressurize fuel in the fuel system to fuel the powertrain;
a deceleration request device configured to provide a deceleration request to decelerate the vehicle; and
at least one controller configured to receive the deceleration request and output one or more braking commands to the fuel system, wherein the one or more braking commands from the controller decelerate the vehicle by increasing the pressure of the fuel system with the fuel pump to add torque to the powertrain to decelerate the vehicle.

12. The vehicle according to claim 11, wherein the fuel system includes a pressure relief valve downstream of the fuel pump, and the one or more braking commands opens the pressure relief valve in response to the deceleration request.

13. The vehicle according to claim 12, wherein the fuel system includes an inlet metering valve upstream of the fuel pump that opens in response to the pressure relief valve opening to provide fuel to the fuel pump during deceleration without fueling the powertrain.

14. The vehicle according to claim 12, wherein the fuel system includes a common rail connected to a plurality of fuel injectors, and the pressure relief valve is to connected to the common rail upstream of the plurality of fuel injectors.

15. The vehicle according to claim 12, wherein the pressure relief valve is connected to a fuel tank of the fuel system so that fuel from the fuel pump flows through the pressure relief valve to the fuel tank during deceleration of the vehicle.

16. The vehicle according to claim 12, wherein the controller is configured to modulate an opening of the pressure relief valve from a fully open position that maximizes a braking capability of the fuel pump to an intermediate position in which the braking capability of the fuel pump is less than its maximum.

17. The vehicle according to claim 11, wherein the fuel system includes a mechanical dump valve downstream of the fuel pump, and the one or more braking commands increases a pressure of the fuel system to open the mechanical dump valve in response to the deceleration request.

18. The vehicle according to claim 11, wherein the powertrain includes an internal combustion engine capable of rotating the drive shaft and the deceleration request device comprises a brake pedal.

19. The vehicle according to claim 11, comprising a service braking system and at least one of an exhaust braking system and an engine braking system.

20. The vehicle according to claim 19, wherein the at least one controller is configured to output one or more braking commands to the at least one of the exhaust braking system and the engine braking system to decelerate the vehicle in addition to using the fuel pump to decelerate the vehicle.
